(19) United States
(12) Patent Application Publication
(10) Pub. No.: US 2003/0105763 A1
(43) Pub. Date: Jun. 5, 2003

(54) System, method, and computer program product for providing a wholesale provisioning service

(75) Inventors: Terrence Chatfield, Ashburn, VA (US); Eugene Decarpio, Woodbridge, VA (US); Chris Heermann, Springfield, VA (US); Kanan Shah, Fairfax, VA (US); Yunqing Wu, Sterling, VA (US); Eugene L. Lew, Olney, MD (US)

Correspondence Address: OBLON, SPIVAK, MCCLELLAND, MAIER & NEUSTADT, P.C., FOURTH FLOOR, 1755 JEFFERSON DAVIS HIGHWAY, ARLINGTON, VA, 22202, US

(73) Assignee: GEMINI NETWORKS, INC., FALLS CHURCH, VA

(21) Appl. No.: 09/996,903

(22) Filed: Nov. 30, 2001

(51) Int. Cl. G06F 7/00

(52) U.S. Cl. 707/10

(57) ABSTRACT

A system, method, and computer program product for providing wholesale provisioning services. End-users are routed to a particular service provider for providing a particular service through an access network based on a service requested by the end-user. Information is maintained in a database as to which service provider has been selected by an end-user for providing a particular service. If the end-user's preferred service provider is unavailable to provide the requested service, an alternate service provider, as specified by the end-user and maintained in the database, may provide the requested service.

### CROSS REFERENCE TO RELATED PATENT DOCUMENTS

The present document contains subject matter related to that disclosed in commonly owned, co-pending application Ser. No. 09/784,074 filed Feb. 16, 2001, entitled SYSTEM, METHOD, AND COMPUTER PROGRAM PRODUCT FOR SUPPORTING MULTIPLE SERVICE PROVIDERS WITH AN INTEGRATED OPERATIONS SUPPORT SYSTEM (Attorney Docket No. 200876US-8), the entire contents of which is incorporated herein by reference.

### BACKGROUND OF THE INVENTION

1. Field of the Invention

The present invention relates to open access networks, and in particular to systems, methods, and computer program products for providing a wholesale provisioning service through the use of various routing techniques.

2 Discussion of the Background

An access network provides connectivity between an end-user of a service and a service provider providing that service. Examples of access networks include the connectivity between an end-user and an Internet service provider (ISP), and the connectivity between an end-user and a voice service provider. An ISP provides connectivity between end-users and the Internet, whereas a voice service provider provides connectivity between end-users and, for example, a plain old telephone system (POTS), or the Internet (for voice-over-Internet protocol (IP) service. Using this definition of an access network, access networks provide connectivity between end-users and services including, but not limited to, Internet access, voice services, cable television, and other video services.

In order for an end-user to receive these services, the end-user typically enters into a service contract with a service provider for each of the services desired. For example, any one end-user may enter into separate service contracts for Internet access, cable television, local telephone service, long distance telephone service, voice-over-IP service, video-on-demand service, etc.

It is common for each of these individual services to be delivered to an end-user via a separate access network. For example, it is common for an end-user to have at their location, a telephone connection, a cable television connection, and an Internet connection. Other access networks may be provided through satellite communications, or cellular communications. As an end-user switches from one service provider to another service provider, it is not uncommon for a new access network connection to be provided to that end-user.

### SUMMARY OF THE INVENTION

The inventors of the present invention have recognized that currently no methods, systems, or computer program products are available to allow end-users to gain access to many services provided through disparate service providers by accessing a single, open access, access network. The inventors of the present invention have recognized that it would be advantageous to provide a wholesale provisioning service that provides connectivity between end-users and an unlimited number of service providers offering a variety of services through a single access network. The wholesale provisioning service includes a data center that provides a network path from the end-user to the appropriate service provider based on a service requested by the end-user. The open access environment allows end-users to easily select which service provider they desire to provide a particular service. Furthermore, end-users may designate alternate service providers to provide the service when that service is not available through their selected preferred service provider.

The present invention includes a novel computer-based system, method, and computer program product through which a wholesale provisioning service is provided by connecting end-users to service providers based on a service being requested. The system includes a data center that provides routing based on information maintained in a digital repository of the data center. The information maintained in the digital repository identifies which service provider has been selected by the end-user to provide a particular service (e.g., a subscription). The digital repository also includes information identifying alternate service providers for providing a particular service when the service is unavailable from the selected preferred service provider.

In one embodiment, the present invention is implemented as a system for routing an end-user to a first service provider for providing a first service over an open access network, and to a second service provider for providing a second service over the open access network. The system includes a digital repository for maintaining information as to which service provider has been selected by an end-user for providing a particular service. The system also includes the ability to receive a request for a particular service from an end-user and to query the digital repository to determine which service provider has been selected by that end-user for providing that particular service. The system provides a network path from the end-user to the appropriate service provider for providing that particular service to that end-user.

Consistent with the title of this section, the above summary is not intended to be an exhaustive discussion of all the features or embodiments of the present invention. A more complete, although not necessarily exhaustive, description of the features and embodiments of the invention is found in the section entitled “DESCRIPTION OF THE PREFERRED EMBODIMENTS”.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram of an open access network system for providing connectivity between end-users and multiple service providers providing a variety of services through a single access network according to one embodiment of the present invention;

FIG. 2A is a block diagram of a system configuration of an operations support system of an open access network providing connectivity between end-users and multiple service providers according to one embodiment of the present invention;

FIG. 2B is a block diagram of a system configuration of an operations support system including a distributed database that may reside in different geographic locations according to one embodiment of the present invention;

FIG. 3 is a block diagram illustrating mechanisms of a data center according to one embodiment of the present invention

FIGS. 4A-4C are a flowchart of a process through which end-users are associated with particular service providers for providing particular services, and the routing of those end-users upon receipt of a request for a service according to one embodiment of the present invention;

FIG. 5 is a flowchart of a process through with an alternate service provider for a particular service is assigned by a process of the operations support system according to one embodiment of the present invention;

FIG. 6 illustrates an exemplary database structure for a database of a data center providing multiple services to end-users through multiple service providers according to one embodiment of the present invention; and

FIG. 7 is an exemplary computer system programmed to perform one or more of the special purpose functions of the present invention.

### DESCRIPTION OF THE PREFERRED EMBODIMENTS

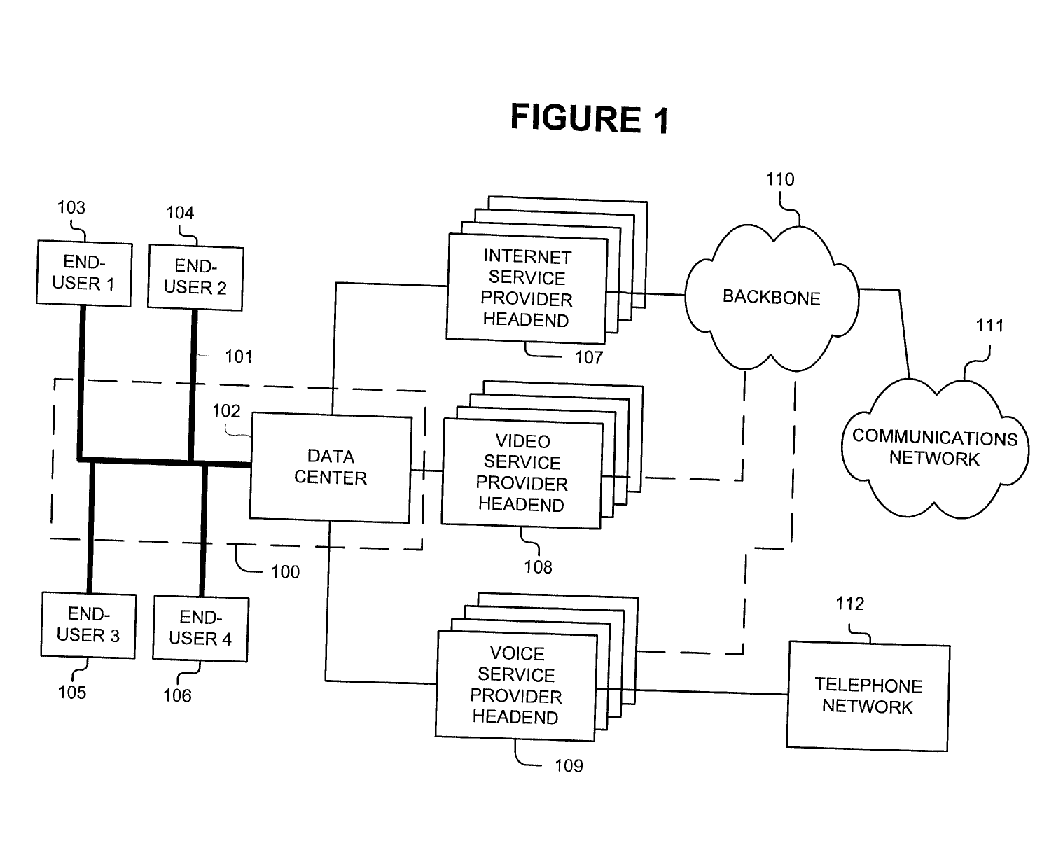

Referring now to the drawings, wherein like reference numerals designate identical or corresponding parts throughout the several views, and more particularly, to FIG. 1 thereof, which is a block diagram of an open access network system for providing a wholesale provisioning service by providing connectivity between end-users and multiple service providers providing services. The system includes an open access network 100 for providing end-users 103-106 with connectivity to multiple service providers 107-109 through a data center 102. End-users 103-106 are connected to the data center 102 through an access network 101. The data center 102 routes end-users 103-106 to one of the service providers 107-109 based on a service requested by a particular end-user 103-106. In one embodiment of the present invention, the access network 101 is a hybrid fiber optic/coaxial (HFC) network. In other embodiments, the access network 101 may be any type of access network including, but not limited to, a digital subscriber line, a dial-up connection, a fiber optic connection, a coaxial connection, a twisted pair connection, a cat5 connection, a cat5e connection, a cat6 connection, or a combination of two or more of these connections.

FIG. 1 illustrates one exemplary system configuration, in which multiple service providers 107-109 provide various services through the open access network 100 to end-users 103-106. In the example shown in FIG. 1, three types of service providers 107-109 are connected to the open access network 100 for providing services to the end-users 103-106.

Multiple Internet service providers (ISP) 107 provide connectivity between end-users 103-106 and a communications network 111 (e.g., the Internet) through a backbone 110. Multiple video service providers 108 (e.g., cable television service providers) provide various video services including, but not limited to, cable television, or video-on-demand services through the open access network 100 to the end-users 103-106. Multiple voice service providers 109 (e.g., telephone companies) provide various voice services, including, but not limited to, long distance service, local service, or voice-over-IP services through the open access network 100 to the end-users 103-106.

As shown in FIG. 1, a voice service provider's head end provides connectivity between the open access network 100 and a service network, for example, a plain old telephone system (POTS) 112. Those voice service providers providing voice-over-IP would provide connectivity to the communications network 111, for example, the Internet, through a backbone 110. As would be understood by those of ordinary skill in the communications networking art, service providers 107-109 are not limited as to which type of services they may provide to their customers. For example, it is common for video service providers 108 to provide both digital video service and Internet access. To generalize, the service provider provides the connectivity between their customers (i.e., end-users 103-106) and the services that the service provider provides. As shown in FIG. 1, the connectivity between the service providers and the end-users 103-106 is through an open access network 100, the benefits of which will be described herein.

The details of the network configuration shown in FIG. 1 including the connectivity between the end-users 103-106 and the open access network 100, as well as the connectivity between the open access network 100 and the various service providers 107-109, are disclosed in application Ser. No. 09/784,074 entitled “SYSTEM, METHOD, AND COMPUTER PROGRAM PRODUCT FOR SUPPORTING MULTIPLE SERVICE PROVIDERS WITH AN INTEGRATED OPERATIONS SUPPORT SYSTEM”.

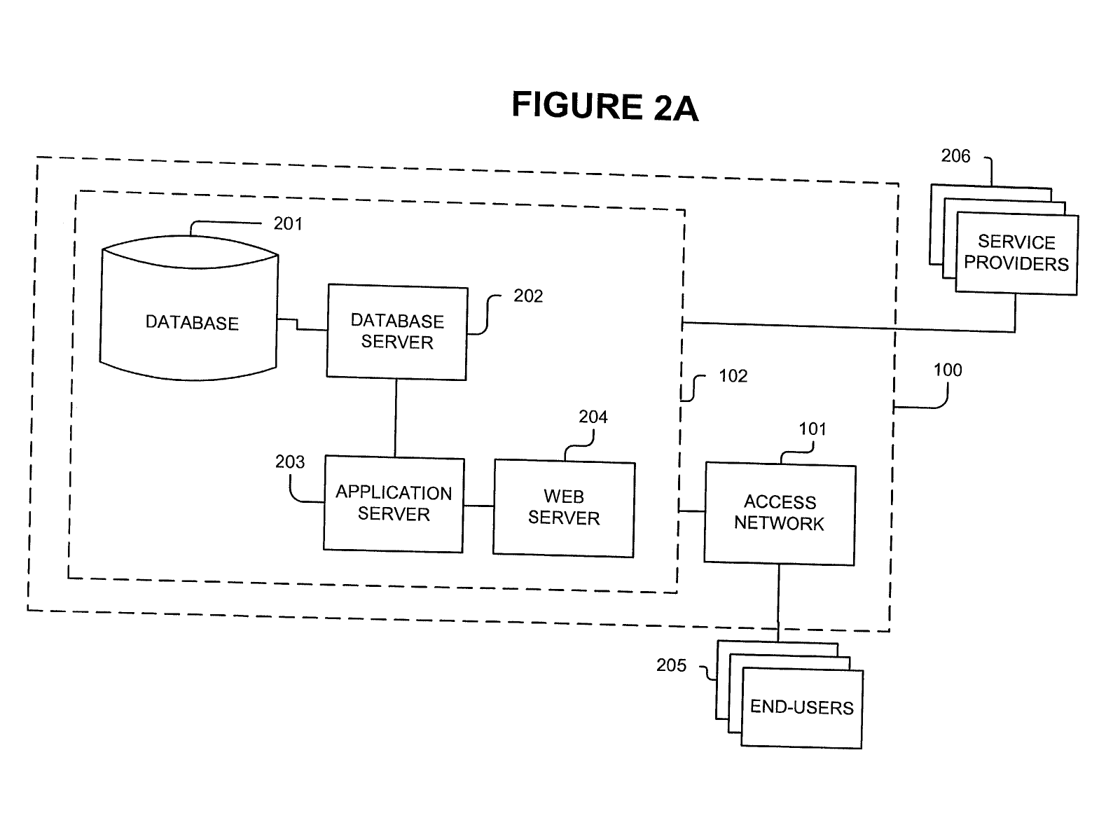

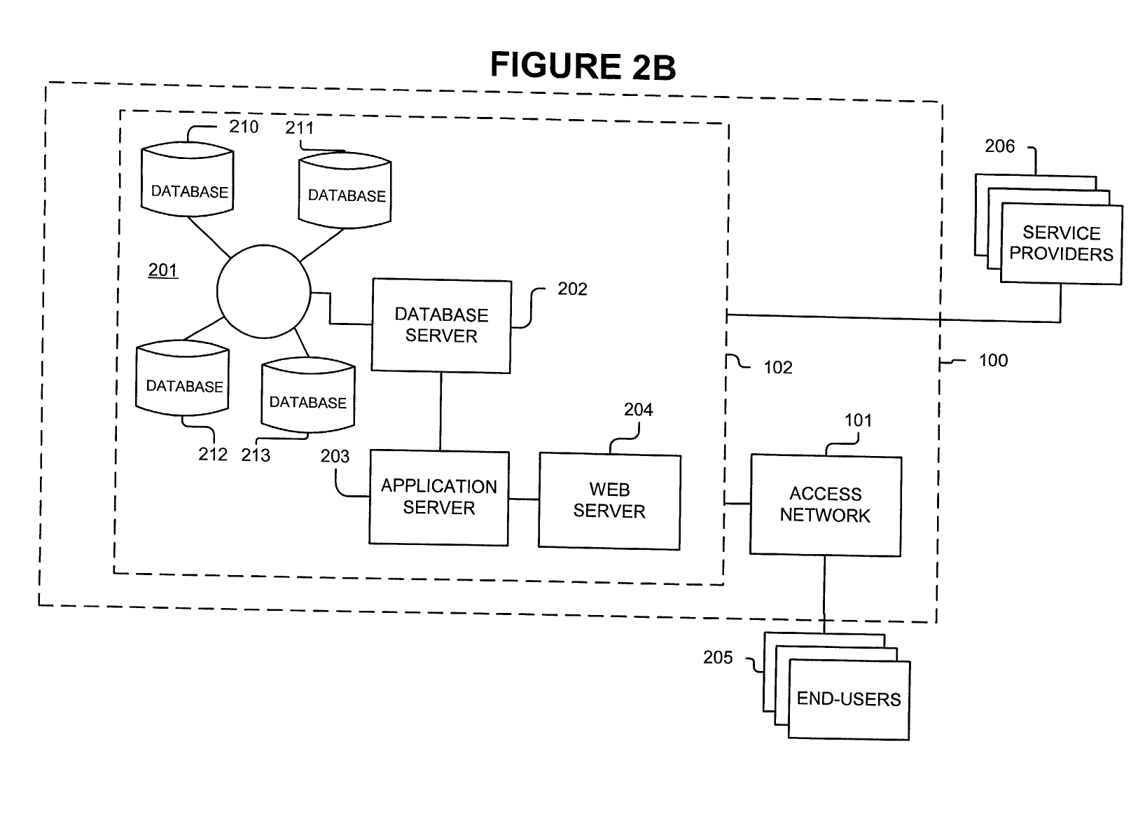

FIG. 2A is a block diagram of a system configuration of an operations support system including a data center 102 of an open access network 100 for providing connectivity between end-users 103-106 and multiple service providers 107-109. As shown in FIG. 2A, in one embodiment of the present invention, end-users 205 are connected to the data center 102 through an access network 101, which, for example, may be a hybrid fiber optical/coaxial (HFC) network. In one embodiment of the present invention, the data center 102 includes a database 201, a database server 202, an application server 203, and a web server 204.

The database 201 is a digital repository that may be implemented, for example, through a commercially available relational database management system (RDBMS) based on the structured query language (SQL) such as ORACLE, DB2, SYBASE, INFORMIX, or MICROSOFT SQL SERVER, through an object-oriented database management system (ODBMS), or through custom database management software. In one embodiment of the present invention, the database 201 includes information concerning the subscription relationships between the end-users 205 and the various service providers 206 for providing a particular service.

In one embodiment of the present invention, the database 201 includes information such as which service provider 107-109 has been selected by a particular end-user 103-106 as their preferred service provider for providing a particular service. The database 201 may also include information as to alternate service providers 107-109 for providing that service to that end-user 103-106 when the service is not available from the selected preferred service provider 107-109.

In one embodiment of the present invention, the database 201 stores “default” service providers 107-109 for each type of service offered (e.g., Internet connectivity, cable television, video-on-demand, voice services, etc.). In this embodiment, if an end-user 103-106 elects not to choose a particular service provider 107-109 for providing a particular service, the system will either select the default service provider 107-109 for that particular service or assign a service provider 107-109 to the end-user 103-106 at random.

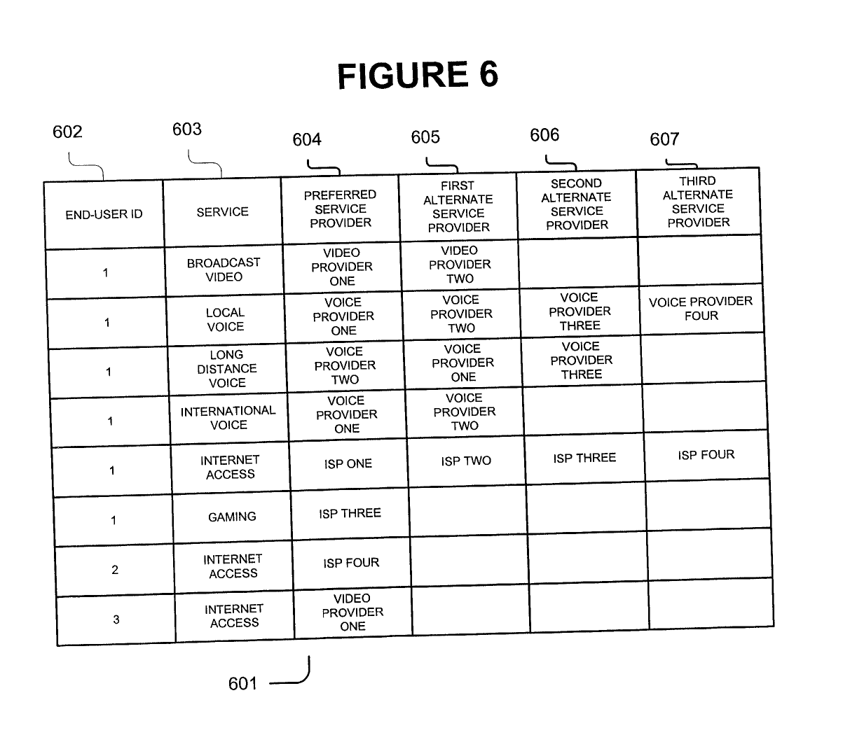

Processes running on the database server 202 maintain the information in the database 201. The database server 202 is implemented using the computer system 601 of FIG. 6, for example, but may also be any other suitable personal computer (PC), workstation, server, or device for maintaining the information in the database 201. The database 201 may reside on a storage device of the database server 202, or reside on another device connected to the database server 202, for example, by way of a local area network, or other communications link such as a virtual private network, fiber channel, wireless link, or Internet-enabled link.

The application server 203 may be implemented using the computer system 601 of FIG. 6, for example, or any other suitable PC, workstation, server, or other device for hosting applications that are used to maintain the information stored in the database 201 and provide routing between end-users 205 and service providers 206 based on services requested. Applications running on the application server 203 interact with the information maintained in the database 201 through the database server 202.

A web server 204 may be implemented using the computer system 601 of FIG. 6, for example, or any other suitable PC, workstation, server, or other device for hosting an interface through which users (e.g., end-users 205) may interact with applications running on the application server 203. In one embodiment of the present invention, the user interface provided by the web server 204 is accessible via the access network 101. In another embodiment, the user interface provided by the web server 204 is a world wide web-based interface accessible through the communications network 111 (e.g., the Internet). In one embodiment of the present invention, end-users 103-106 specify which service provides 107-109 they desire to provide particular services through interactions with a user interface hosted by the web server 204. The user interface accesses applications running on the application server 203 to maintain and query information in the database 201 regarding which service provides 107-109 are to provide which services to the end-users 103-106, and to provide routing between the end-user 103-106 and the appropriate service provider 107-109 based on the information in the database 201 and the service requested.

As an end-user 205 requests a service via the access network 101, an application running on the application server 203 will query the database 201 through the database server 202 to determine which service provider 206 has been selected by this particular end-user 205 to provide the particular service being requested by the end-user 205. The application will then determine a path through which to route the end-user 205 to the selected service provider 206. This determination may be made, for example, using source address routing techniques or multi-protocol label switching (MPLS) techniques. The forwarding path, channel, or tunnel may be either physical or virtual, using known techniques including, but not limited to MPLS, asynchronous transfer mode (ATM), private virtual circuits (PVCs), switched virtual circuits (SVCs), virtual LANs (VLANs), layer two tunneling protocol (L2TP) tunnels and extensions thereto, Internet protocol secure (IPSec) tunneling and extensions thereto, point-to-point tunneling protocol (PPTP) tunneling and extensions thereto, point-to-point protocol over ethernet (PPPOE) and extensions thereto, or other techniques for providing connectivity between the end-user205 and the selected service provider 206 though the access network 101. The service provider 206 will then provide the requested service by providing the end-user 205 with access to a service network maintained by that particular service provider 206. For example, if an end-user 205 is requesting Internet access, the service provider 206 would be an Internet service provider, which would provide access to the communications network 111, for example, the Internet, via that service provider's 206 connection to a backbone 110.

In one embodiment of the present invention, the user interface to applications running on the application server 203 is implemented as a browsable interface developed in a standard markup language (e.g., XML, HTML, DHTML, or HDML, etc.) accessible via commercially available web browser tools including, but not limited to, INTERNET EXPLORER, available from Microsoft Corporation and NETSCAPE NAVIGATOR, available from Netscape Communications Corporation. The commercially available web browser tool running on a workstation of an end-user 103-106 provides accessibility to the applications running on the application server 203 through the web interface provided by the web server 204. In another embodiment, the user interface is provided through a custom interface provided by, for example, one of the service providers 107-109.

Various approaches for accessing applications via the Internet are described in White, R., “How Computers Work,” Que, September 1999, and Gralla, P., “How the Internet Works,” Que, August 1999, the entire contents of both of which are incorporated herein by reference.

FIG. 2B is a block diagram of a system configuration of an operations support system in which the database 201 is implemented as a distributed database according to one embodiment of the present invention. As shown in FIG. 2B, the distributed database 201 includes one or more databases 210-213 managed by processes running on the database server 202. In one embodiment of the present invention, the database server 202 is itself distributed by having one or more processor involved in the management of the distributed database 210 (e.g., each node or cluster of nodes of the distributed database 201 may be co-located with a separate processor responsible for local management of that node or cluster). The individual databases 211-214 are not required to be geographically co-located, nor are the individual databases 211-214 required to have connectivity to one another.

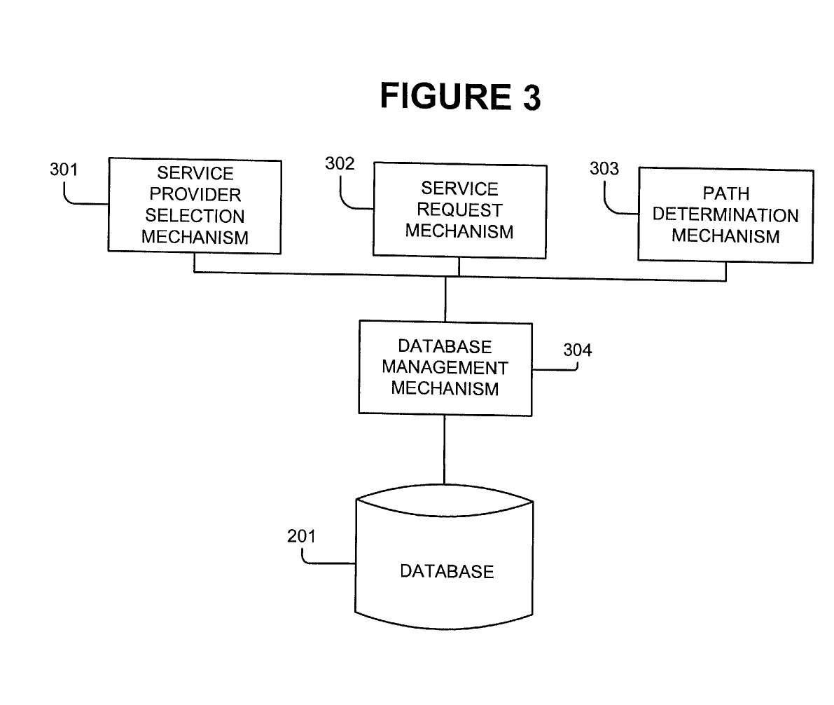

FIG. 3 is a block diagram illustrating mechanisms implemented by the data center 102 according to one embodiment of the present invention. As shown in FIG. 3, the data center 102 includes a service provider selection mechanism 301, a service request mechanism 302, a path determination mechanism 303, and a database management mechanism 304. The service provider selection mechanism 301, the service request mechanism 302, and the path determination mechanism 303 interact with the database 201 through the database management mechanism 304.

The service provider selection mechanism 301 collects and maintains information in the database 201 as to which particular service provider 107-109 is to provide a particular service for a particular end-user 103-106. The service provider selection mechanism 301 includes a user interface through which the end-users 103-106 may interact and provide information that will be stored in the database 201. In one embodiment of the present invention, end-users 103-106 select not only a preferred service provider 107-109 for providing a particular service, but also, may specify alternate service providers 107-109 through which that particular service will be provided in the event the selected preferred service provider 107-109 is unavailable for providing that particular service when it is requested by the end-user 103-106.

In one embodiment of the present invention, if an end user 103-106 does not specify an alternate service provider 107-109 for one or more services, the service provider selection mechanism 301 chooses either a predefined default service provider 107-109 as an alternate service provider 107-109 or a service provider 107-109 at random as an alternate service provider 107-109 for providing those services.

In one embodiment of the present invention, the service request mechanism 302 receives a request for a particular service from a particular end-user 103-106 through the access network 101. In response to the request, the path determination mechanism 303 queries the database 201 via the database management mechanism 304 in order to determine which particular service provider 107-109 has been selected by the requesting end-user 103-106 for providing the requested service. Once it has been determined which service provider 107-109 is the selected preferred service provider 107-109 for providing the requested service to the requesting end-user 103-106, the path determination mechanism 303 provides a network path between the requesting end-user 103-106 and the appropriate service provider 107-109 using, for example, source routing techniques, MPLS techniques, tunneling techniques, or other techniques.

In one embodiment of the present invention, if it is determined that the selected preferred service provider 107-109 is unable to provide the requested service to the requesting end-user 103-106, the path determination mechanism 303 will query the database 201 via the database management mechanism 304 in order to determine if an alternate service provider 107-109 has been identified for providing the requested service to the requesting end-user 103-106. If an alternate service provider 107-109 has been specified, the path determination mechanism 303 will provide a network path between the requesting end-user 103-106 and that alternate service provider 107-109 for providing the requested service. Further alternate service providers (e.g., secondary alternate, tertiary alternate, etc.) may also be specified for providing a particular service and stored in the database 201.

In one embodiment of the present invention, the path determination mechanism 303 is configured to allow the operator of the access network, an authorized agency, a government or other regulatory entity, or other third party to provide a path between the end-user 103-106 and any available service provider 107-109 to ensure that the service requested is made available to the requesting end-user 103-106. In this embodiment, the end-user 103-106 will be ensured to receive the service requested, regardless of the provider of that service.

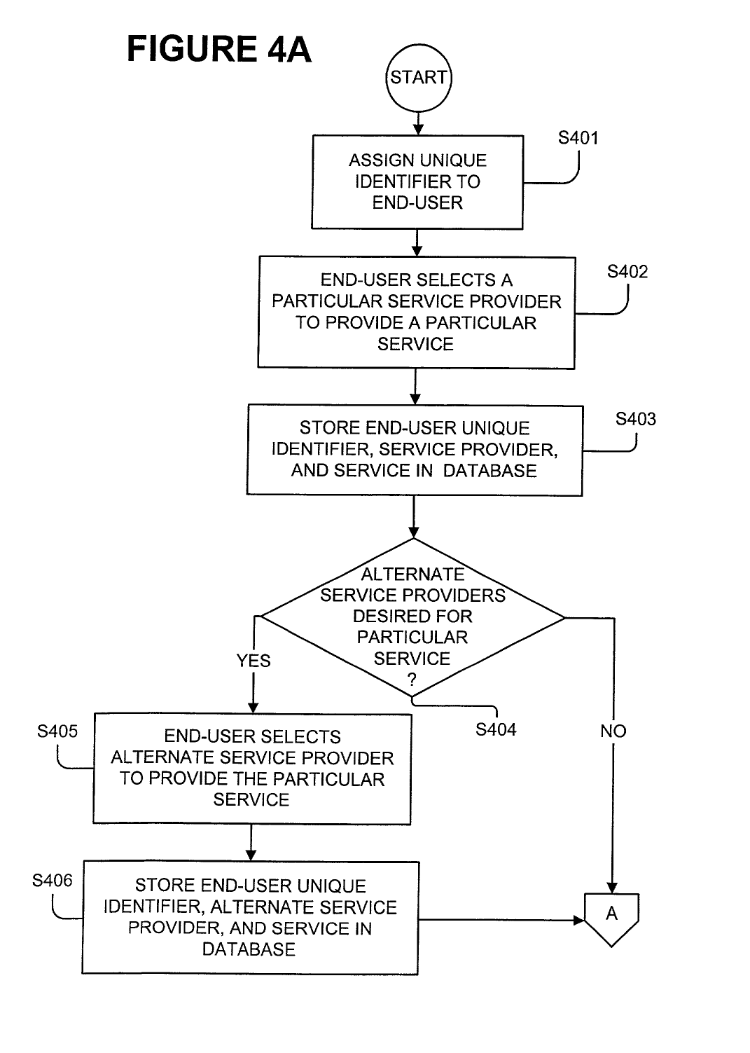

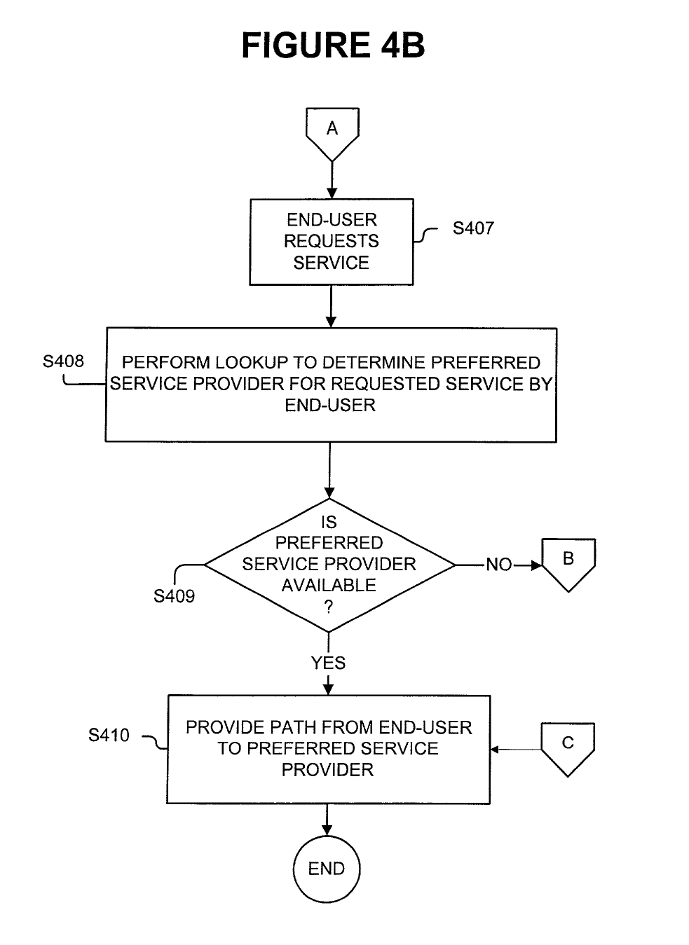

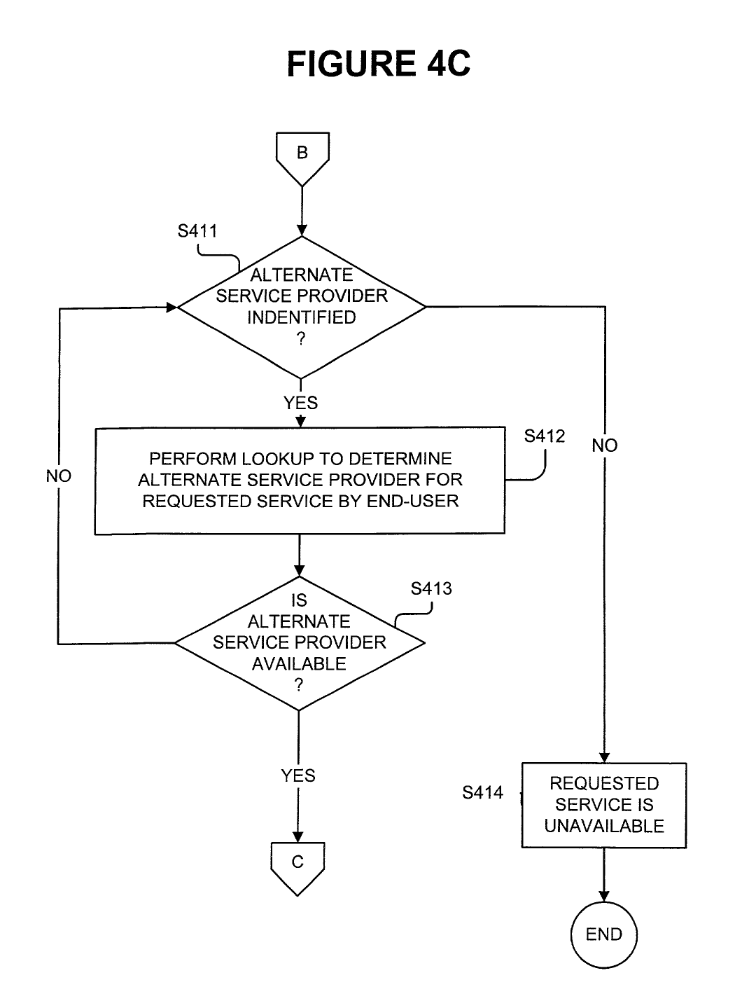

FIGS. 4A-4C are a flowchart of a process through which end-users 103-106 are associated to particular service providers 107-109 for providing particular services, and through which those end-users are routed to the appropriate service provider 107-109 upon receipt of a request for a particular service from a particular end-user 103-106. As shown in FIG. 4A, the process begins at step S401 where a unique identifier is assigned to each individual end-user 103-106. The process then proceeds to step S402 where the end-user 103-106 selects a particular service provider 107-109 to provide a particular service to them. For example, an end-user may select a first service provider 107-109 for providing Internet access, a second service provider 107-109 for providing video-on-demand services, a third service provider 107-109 for providing local telephone service, and a fourth service provider 107-109 for providing long distance telephone service. Once the end-user 103-106 has selected which service providers 107-109 are to provide which services, the process proceeds to step S403 where the unique identifier corresponding to the particular end-user 103-106, an identifier corresponding to the selected service provider 107-109, and an indicator as to which service that end-user 103-106 has selected that service provider 107-109 to provide, are stored in a database 201 of the data center 102. Once that information has been recorded, the process proceeds to step S404 where it is determined whether alternate service providers 107-109 are desired by the end-user 103-106 for providing that particular service.

If it is determined that this particular end-user 103-106 desires to specify alternate service providers 107-109 for providing a particular service (i.e., “Yes” at step S404), the process proceeds to step S405 where the end-user 103-106 selects an alternate service provider 107-109 for providing that particular service. The process then proceeds to step S406 where the end-use's 103-106 unique identifier along with an identifier of the alternate service provider 107-109 and an indicator of the particular service are stored in the database 201 of the data center 102.

If, on the other hand, alternate service providers 107-109 are not desired by this particular end-user 103-106 for providing this particular service (i.e., “No” at step S404), or, upon completing the population of the database with the alternate service provider 107-109 information, the process proceeds to step S407 shown on FIG. 4B, where the end-user 103-106 requests a particular service by a request made through the access network 101.

The process then proceeds to step S408 where a lookup is performed in the database 201 to determine which service provider 107-109 is the preferred service provider 107-109 for providing the service requested by the end-user 103-106. The process then proceeds to step S409 where it is determined whether the preferred service provider 107-109 is available to provide the requested service to the end-user 103-106. If it is determined that the preferred service provider 107-109 is available (e.g., a network path can be established between the end-user and the preferred service provider) to provide the service (i.e., “Yes” at step S409), the process proceeds to step S410 where a network path is provided between the end-user 103-106 and the preferred service provider 107-109. Once the network connection has been made between the end-user 103-106 and the preferred service provider 107-109, the process ends.

If, on the other hand, it is determined that the preferred service provider 107-109 is not available to provide the requested service (i.e., “No” at step S409), the process proceeds to step S411, shown on FIG. 4C, where it is determined whether an alternate service provider 107-109 has been identified for providing the requested service to the requesting end-user 103-106.

If it is determined that alternate service providers 107-109 have been identified (i.e., “Yes” at step S411), the process proceeds to step S412 where the operator of the open access network 100 performs a lookup in the database 201 to determine an alternate service provider 107-109 for providing the requested service to the requesting end-user 103-106. The process then proceeds to step S413 where it is determined whether the alternate service provider 107-109 is available to provide the requested service to the requesting end-user 103-106.

If it is determined that the alternate service provider is not available to provide the requested service to the requesting end-user 103-106 (i.e., “No” at step S413), the process returns to step S411 to check for further alternate service providers 107-109.

If, on the other hand, it is determined that alternate service providers 107-109 have not been identified for providing the requested service to the requesting end-user 103-106 (i.e., “No” at step S411), the process proceeds to step S414 where a determination is made that the requested service is unavailable to the requesting end-user 103-106 through the service providers 107-109 selected (i.e., both preferred and alternate) by that end-user 103-106. Once this determination is made, the process ends. In another embodiment of the present invention, rather than denying the requested service to the end-user 103-106, the system will select a service provider 107-109 that is available to provide the requested service. In this embodiment, the system may either select a system default service provider 107-109, or randomly assign a service provider 107-109 to provide the requested service to the end-user 103-106.

If, on the other hand, it is determined that an alternate service provider 107-109 is available to provide the requested service to the requesting end-user 103-106 (i.e., “Yes” at step S413), the process proceeds to step S410 shown on FIG. 4B, where a path is provided from the requesting end-user 103-106 to the available alternate service provider 107-109.

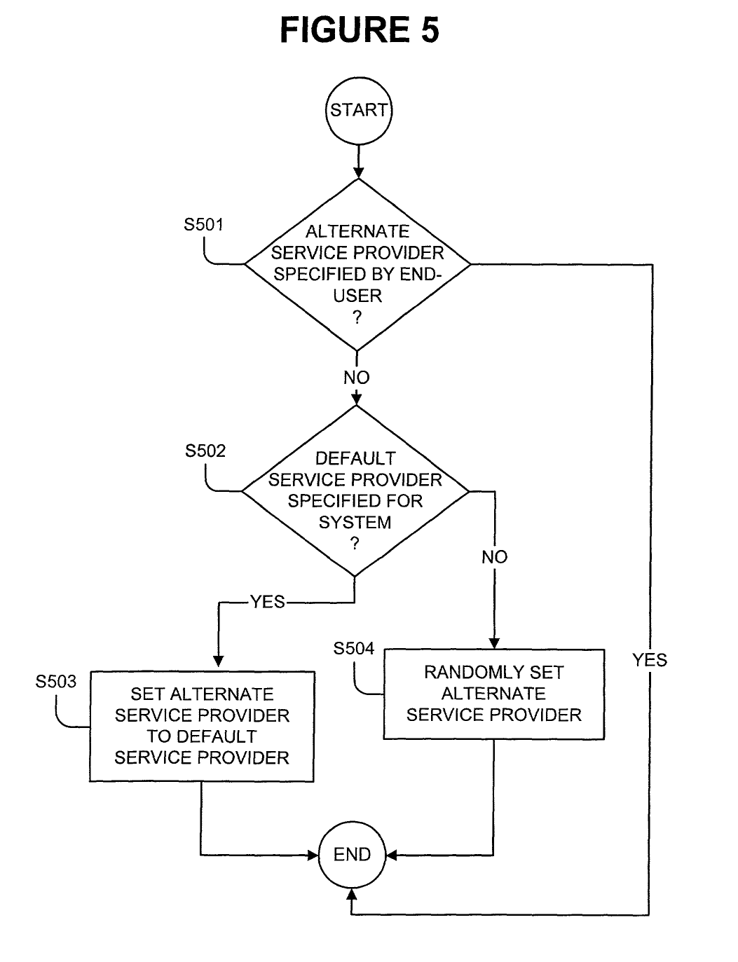

FIG. 5 is a flowchart of a process through which an alternate service provider 107-109 for one or more particular services is assigned to an end-user 103-106 by a process of the operations support system according to one embodiment of the present invention. In one embodiment of the present invention, this process is performed as an end-user's 103-106 information is configured in the database 201. In another embodiment, the assignment of an alternate service provider 107-109 is made dynamically by the system as a need arises. As shown in FIG. 5, the process begins at step S501 where it is determined if an alternate service provider 107-109 to provide a particular service to an end-user 103-106 has been specified by the end-user 103-106. If it determined that an alternate service provider 107-109 for a particular service has been specified by the end-user 103-106 (i.e., “Yes” at step S501), the process ends. On the other hand, if it determined that the end-user 103-106 has not specified an alternate service provider 107-109 for a particular service (i.e., “No” at step S501), the process proceeds to step S502 where it is determined whether the system has a default service provider 107-109 defined for the particular service.

If the system has a default service provider 107-109 defined for the particular service (i.e., “Yes” at step S502), the process proceeds to step S503 where the default service provider 107-109 is assigned to the end-user 103-106 as the alternate service provider 107-109 for the particular service. Once the default service provider 107-109 has been assigned to the end-user 103-106, the process ends. If, on the other hand, the system does not have a default service provider 107-109 defined for the particular service (i.e., “No” at step S502), the process proceeds to step S504 where an alternate service provider 107-109 is randomly selected and assigned to the end-user 103-106 for the particular service. Once the randomly selected service provider 107-109 has been assigned to the end-user 103-106, the process ends.

FIG. 6 illustrates an exemplary database structure for a database 201 of a data center 102 for capturing information associating particular end-users 103-106 and particular service providers 107-109 for providing particular services. As shown in FIG. 6, the exemplary database structure includes an end-user ID column 601 for capturing an identification indicator to uniquely identify a particular end-user 103-106. The end-user ID may be, for example, a number, an IP address, a MAC address, a telephone number, a port number, a local area network (LAN) tag, a virtual LAN (VLAN) tag, a MPLS label, a label-switched path (LSP) label, a tag, a label, a serial number, a social security number, or any other number or label for uniquely identifying a particular end-user 103-106. The end-user ID may be assigned in a number of ways, including, but not limited to, assigned permanently, semi-permanently, statically, or dynamically. The end-user ID may be assigned by, for example, the end-user 103-106, the operator of the access network, the service provider 107-109, a third party, an authorized agency, or a regulatory or other governing entity. Each entry of the database structure 601 also includes a service column 603. The service column captures the particular service being requested by the particular end-user 103-106. Exemplary services include broadcast video, local voice, long distance voice, international voice, Internet access, gaming, video-on-demand services, voice-over-internet protocol services, etc.

Also included in the database structure 601 are several columns 604-607 for specifying which particular service provider 107-109 has been selected by the end-user 103-106 corresponding to the unique end-user ID for providing the particular service. In this exemplary structure 601, a preferred service provider column 604 captures the preferred service provider 107-109 for providing the particular service. Also included in this exemplary structure 601 are a first alternate service provider column 605, a second alternate service provider column 606, and a third alternate service provider column 607. In another embodiment of the present invention, alternate service providers may not be specified. In yet another embodiment, more alternate service providers may be specified than the three alternates 605-607 in the example illustrated in FIG. 6. Each of the alternate service provider columns 605-607 capture alternate service providers 107-109 for providing the particular service to the end-user 103-106 when the preferred service provider is not available for providing that service.

Using data from the exemplary structure 601 shown in FIG. 6, if end-user 1 103 were to request Internet access by issuing a request over the access network 101, the data center 102 would provide a path between end-user 1 103 and ISP ONE, if ISP ONE was available to provide Internet access to end-user 1 103 at the time of the request. If, on the other hand, ISP ONE was not available, the data center 102 would provide a path to the first alternate service provider, or, in this case, ISP TWO, to provide Internet access to end-user 1 103. This process would repeat if the alternate service provider (e.g., ISP TWO) were unavailable until an available service provider was found, or all specified alternate service providers (e.g., ISP THREE and ISP FOUR) were exhausted.

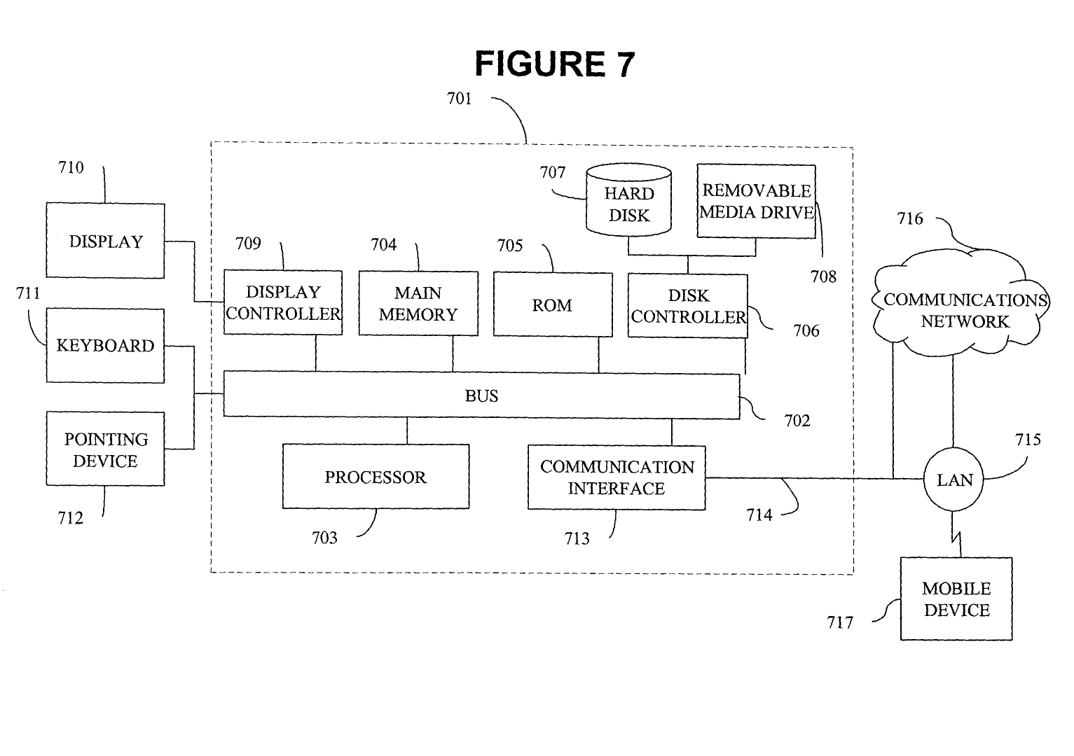

FIG. 7 is an exemplary computer system programmed to perform one or more of the special purpose functions of the present invention. The present invention may be implemented on a single such computer system, or a collection of multiple such computer systems. The computer system 701 includes a bus 702 or other communication mechanism for communicating information, and a processor 703 coupled with the bus 702 for processing the information. The computer system 701 also includes a main memory 704, such as a random access memory (RAM) or other dynamic storage device (e.g., dynamic RAM (DRAM), static RAM (SRAM), Rambus dynamic RAM (RDRAM), and synchronous DRAM (SDRAM)), coupled to the bus 702 for storing information and instructions to be executed by processor 703. In addition, the main memory 704 may be used for storing temporary variables or other intermediate information during the execution of instructions by the processor 703. The computer system 701 further includes a read only memory (ROM) 705 or other static storage device (e.g., programmable ROM (PROM), erasable PROM (EPROM), and electrically erasable PROM (EEPROM)) coupled to the bus 702 for storing static information and instructions for the processor 703.

The computer system 701 also includes a disk controller 706 coupled to the bus 702 to control one or more storage devices for storing information and instructions, such as a magnetic hard disk 707, and a removable media drive 708 (e.g., floppy disk drive, read-only compact disc drive, read/write compact disc drive, compact disc jukebox, tape drive, and removable magneto-optical drive). The storage devices may be added to the computer system 701 using an appropriate device interface (e.g., small computer system interface (SCSI), integrated device electronics (IDE), enhanced-IDE (E-IDE), Universal Serial Bus (USB), IEEE-1394 (i.e., “Firewire”), Fiber-channel, direct memory access (DMA), or ultra-DMA).

The computer system 701 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 701 may also include a display controller 709 coupled to the bus 702 to control a display 710, such as a cathode ray tube (CRT), for displaying information to a computer user. The CRT may provide visual feedback, for example, over a network connection (e.g., LAN, WAN, Internet, etc.). The computer system includes input devices, such as a keyboard 711 and a pointing device 712, for interacting with a computer user and providing information to the processor 703. The pointing device 712, for example, may be a mouse, a trackball, or a pointing stick for communicating direction information and command selections to the processor 703 and for controlling cursor movement on the display 710. In addition, a printer may provide printed listings of the data structures/information, or any other data stored and/or generated by the computer system 701.

The computer system 701 performs a portion or all of the processing steps of the invention in response to the processor 703 executing one or more sequences of one or more instructions contained in a memory, such as the main memory 704. Such instructions may be read into the main memory 704 from another computer readable medium, such as a hard disk 707 or a removable media drive 708. One or more processors in a multi-processing arrangement may also be employed to execute the sequences of instructions contained in main memory 704. In alternative embodiments, hard-wired circuitry may be used in place of or in combination with software instructions. Thus, embodiments are not limited to any specific combination of hardware circuitry and software.

As stated above, the computer system 701 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, RDRAM, SDRAM, or any other magnetic medium, compact discs (e.g., CD-ROM or DVD), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 701, for driving a device or devices for implementing the invention, and for enabling the computer system 701 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes and/or libraries, virtual machines and complete executable programs. Moreover, parts of the processing of the present invention may be distributed for better performance, reliability, and/or cost.

The term “computer readable medium” as used herein refers to any medium that participates in providing instructions to the processor 703 for execution. A computer readable medium may take many forms, including but not limited to, non-volatile media, volatile media, and transmission media. Non-volatile media includes, for example, optical, magnetic disks, and magneto-optical disks, such as the hard disk 707 or the removable media drive 708. Volatile media includes dynamic memory, such as the main memory 704. Transmission media includes coaxial cables, copper wire and fiber optics, including the wires that make up the bus 702. Transmission media also may also take the form of acoustic or light waves, such as those generated during radio wave and infrared data communications.

Various forms of computer readable media may be involved in carrying out one or more sequences of one or more instructions to processor 703 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 701 may receive the data on the telephone line and use an infrared transmitter to convert the data to an infrared signal. An infrared detector coupled to the bus 702 can receive the data carried in the infrared signal and place the data on the bus 702. The bus 702 carries the data to the main memory 704, from which the processor 703 retrieves and executes the instructions. The instructions received by the main memory 704 may optionally be stored on storage device 707 or 708 either before or after execution by processor 703.

The computer system 701 also includes a communication interface 713 coupled to the bus 702. The communication interface 713 provides a two-way data communication coupling to a network link 714 that is connected to, for example, a local area network (LAN) 715, or to another communications network 716 such as the Internet. For example, the communication interface 713 may be a network interface card to attach to any packet switched LAN. As another example, the communication interface 713 may be a digital subscriber line (DSL) card, an integrated services digital network (ISDN) card or a modem to provide a data communication connection to a corresponding type of communications line. Wireless links may also be implemented. In any such implementation, the communication interface 713 sends and receives electrical, electromagnetic or optical signals that carry digital data streams representing various types of information.

The network link 714 typically provides data communication through one or more networks to other data devices. For example, the network link 714 may provide a connection to another computer through a local network 715 (e.g., a LAN) or through equipment operated by a service provider, which provides communication services through a communications network 716. In preferred embodiments, the local network 714 and the communications network 716 preferably use electrical, electromagnetic, or optical signals that carry digital data streams. The signals through the various networks and the signals on the network link 714 and through the communication interface 713, which carry the digital data to and from the computer system 701, are exemplary forms of carrier waves transporting the information. The computer system 701 can transmit and receive data, including program code, through the network(s) 715 and 716, the network link 714 and the communication interface 713. Moreover, the network link 714 may provide a connection through a LAN 715 to a mobile device 717 such as a personal digital assistant (PDA), laptop computer, or cellular telephone. The LAN communications network 715 and the communications network 716 both use electrical, electromagnetic or optical signals that carry digital data streams. The signals through the various networks and the signals on the network link 714 and through the communication interface 713, which carry the digital data to and from the system 701, are exemplary forms of carrier waves transporting the information. The computer system 701 can transmit notifications and receive data, including program code, through the network(s), the network link 714 and the communication interface 713.

Obviously, numerous modifications and variations of the present invention are possible in light of the above teachings. It is therefore to be understood that within the scope of the appended claims, the invention may be practiced otherwise than as specifically described herein.

What we claim is:

1. A system for routing a plurality of end-users through an access network to a plurality of service providers based on a request for a particular service of a plurality of services, comprising:
a service provider selection mechanism configured to relate a particular service provider to a particular end-user for providing the particular service to the particular end-user; and
a path determination mechanism configured to route the particular end-user through the access network to the particular service provider when the particular end-user requests the particular service.

2. The system of claim 1, wherein the service provider selection mechanism comprises a database.

3. The system of claim 2, wherein the database comprises a distributed database.

4. The system of claim 2, wherein the database is populated with a plurality of end-user service entries, each end-user service entry including
an end-user identification indicator corresponding to a unique one of the plurality of end-users,
a selected service indicator corresponding to a selected one of the plurality of services, and
a selected service provider indicator corresponding to a selected one of the plurality of service providers selected to provide the selected one of the plurality of services to the unique one of the plurality of end-users.

5. The system of claim 4, wherein the end-user identification indicator comprises at least one of a number, an Internet protocol address, a media access control address, a telephone number, a port number, a local area network tag, a virtual local area network tag, a multi-protocol label switching label, a label-switched path label, a label, a tag, a serial number, and a social security number.

6. The system of claim 4, wherein:
the service provider selection mechanism is further configured such that at least one of an operator of the access network, an authorized agency, a governing entity, a regulatory entity, one of the plurality of end-users, one of the plurality of service providers, and a third party can populate the end-user identification indicator for the particular end-user in the database.

7. The system of claim 1, wherein:
the request is made over the access network providing a communication path between the particular end-user and a data center,
the path determination mechanism is further configured to route the particular end-user through the access network to the particular service provider, and
the particular service provider provides the particular end-user with access to a service network providing the particular service.

8. The system of claim 7, wherein the service network comprises at least one of an Internet protocol network, the Internet, a data network, a video network, and a voice network.

9. The system of claim 1, wherein the access network comprises an open access network.

10. The system of claim 1, wherein the access network comprises at least one of a hybrid fiber optic/coaxial network, a digital subscriber line, a dialup connection, a fiber optic connection, a coaxial connection, a twisted pair connection, a cat5 connection, a cat5e connection, and a cat6 connection.

11. The system of claim 1, wherein the plurality of service providers comprise at least one of an Internet service provider, a telephone company, a cable television company, a video content provider, a voice-over-Internet protocol provider, and a data services provider.

12. The system of claim 1, further comprising:
a data center configured to provide connectivity between the access network and a plurality of service networks, wherein
the plurality of end-users access the data center via the access network, and
the data center is configured to route end-users to the plurality of service networks via the plurality of service providers.

13. The system of claim 1, wherein the plurality of services comprise at least one of data services, Internet access, voice services, telephone services, teleconferencing services, long distance telephone service, local telephone service, video services, video conferencing services, video on demand services, and cable television services.

14. The system of claim 1, wherein the path determination mechanism is further configured to route the particular end-user to the particular service provider by selecting at least one of a forwarding path, a channel, and a tunnel.

15. The system of claim 1, wherein the path determination mechanism is further configured to route the particular end-user to the particular service provider using at least one of source address routing, multi-protocol label switching, asynchronous transfer mode, private virtual circuits, switched virtual circuits, virtual local area networks, layer two tunneling protocol tunnels, Internet protocol secure tunnels, point-to-point tunneling protocol tunnels, and point-to-point protocol over ethernet.

16. The system of claim 1, wherein:
the path determination mechanism is further configured to route the particular end-user to an alternate service provider of the plurality of service providers when a path is not available from the particular end-user to the particular service provider, and
the service provider selection mechanism is further configured to relate the alternate service provider to the particular end-user for alternately providing the particular service to the particular end-user.

17. The system of claim 4, wherein each end-user service entry further includes
an alternate service provider indicator corresponding to another one of the plurality of service providers for alternately providing the selected one of the plurality of services to the unique one of the plurality of end-users.

18. The system of claim 17, wherein:
the service provider selection mechanism is further configured to populate the alternate service provider indicator by at least one of
assigning a default service provider of the plurality of service providers for providing the selected one of the plurality of services,
randomly assigning a random service provider of the plurality of service providers for providing the selected one of the plurality of services based on a random selection, and
assigning a user-specified service provider of the plurality of service providers for providing the selected one of the plurality of services based on a user input.

19. The system of claim 1, wherein:
the path determination mechanism is further configured such that at least one of an operator of the access network, an authorized agency, a governing entity, a regulatory entity, and a third party can cause the particular end-user to be routed to an available one of the plurality of service providers for providing the particular service when it is determined that an acceptable path between the particular end-user and the particular service provider cannot not established.

20. A system for routing an end-user of a plurality of end-users to a first service provider of a plurality of service providers for providing a first service over an open access network and to a second service provider of the plurality of service providers for providing a second service over the open access network, comprising:
a digital repository populated with a plurality of end-user service entries, each end-user service entry including
an end-user identification indicator corresponding to a unique one of the plurality of end-users,
a selected service indicator corresponding to a selected one of the first service and the second service, and
a selected service provider indicator corresponding to a selected one of the first service provider and the second service provider selected to provide the selected one of the first service and the second service to the unique one of the plurality of end-users;
a processor; and
a computer readable medium encoded with processor readable instructions that when executed by the processor implement
a service provider selection mechanism configured to populate the digital repository with an end-user service entry,
a service request mechanism configured to accept a request from the end-user for a requested one of the first service and the second service,
a path determination mechanism configured to query the digital repository for a retrieved end-user service entry based on the end-user and the requested one of the first service and the second service and to provide a network path from the end-user to a selected one of the first service provider and the second service provider, the selected one of the first service provider and the second service provider being determined based on information stored in the retrieved end-user service entry.

21. The system of claim 20, wherein
the request is made over an access network providing a communication path between the end-user and a data center,
the network path comprises a path from the end-user through the access network to the selected one of the first service provider and the second service provider, and
the selected one of the first service provider and the second service provider provides access to a service network providing the requested one of the first service and the second service.

22. The system of claim 20, wherein the open access network comprises at least one of a hybrid fiber optic/coaxial network, a digital subscriber line, a dialup connection, a fiber optic connection, a coaxial connection, a twisted pair connection, a cat5 connection, a cat5e connection, and a cat6 connection.

23. The system of claim 21, wherein the service network comprises at least one of an Internet protocol network, the Internet, a data network, a video network, and a voice network.

24. The system of claim 20, wherein at least one of the first service provider and the second service provider comprise at least one of an Internet service provider, a telephone company, a cable television company, a video content provider, a voice-over-Internet protocol provider, and a data services provider.

25. The system of claim 20, wherein at least one of the first service and the second service comprises at least one of data services, Internet access, voice services, telephone services, teleconferencing services, long distance telephone service, local telephone service, video services, video conferencing services, video on demand services, and cable television services.

26. The system of claim 20, wherein the end-user identification indicator comprises at least one of a number, an Internet protocol address, a media access control address, a telephone number, a port number, a local area network tag, a virtual local area network tag, a multi-protocol label switch label, a label-switched path label, a label, a tag, a serial number, and a social security number.

27. The system of claim 20, wherein the path determination mechanism is further configured to route the end-user to the selected one of the first service provider and the second service provider by selecting at least one of a forwarding path, a channel, and a tunnel.

28. The system of claim 20, wherein:
the path determination mechanism is further configured to route the end-user to the selected one of the first service provider and the second service provider using at least one of source address routing, multi-protocol label switching, asynchronous transfer mode, private virtual circuits, switched virtual circuits, virtual local area networks, layer two tunneling protocol tunnels, Internet protocol secure tunnels, point-to-point tunneling protocol tunnels, and point-to-point protocol over ethernet.

29. The system of claim 20, wherein:
each end-user service entry fuirther includes
an alternate service provider indicator corresponding to an alternate one of the first service provider and the second service provider selected to alternately provide the requested one of the first service and the second service to the end-user, and
the path determination mechanism is further configured to route the end-user to the alternate one of the first service provider and the second service provider to provide the requested one of the first service and the second service when a path is not available from the end-user to the selected one of the first service provider and the second service provider.

30. The system of claim 29, wherein:
the service provider selection mechanism is further configured to populate the alternate service provider indicator by at least one of
assigning a default service provider of the plurality of service providers for providing the requested one of the first service and the second service,
randomly assigning a random service provider of the plurality of service providers for providing the requested one of the first service and the second service based on a random selection, and
assigning a user-specified service provider of the plurality of service providers for providing the requested one of the first service and the second service based on a user input.

31. The system of claim 20, wherein:
the digital repository comprises a database.

32. The system of claim 31, wherein:
the database comprises a distributed database.

33. The system of claim 20, wherein:
the service provider selection mechanism is further configured such that at least one of an operator of the access network, an authorized agency, a governing entity, a regulatory entity, one of the plurality of end-users, one of the plurality of service providers, and a third party can populate the end-user identification indicator for the end-user in the database.

34. The system of claim 20, wherein:
the path determination mechanism is further configured to route the end-user to the selected one of the first service provider and the second service provider using at least one of source address routing, multi-protocol label switching, asynchronous transfer mode, private virtual circuits, switched virtual circuits, and virtual local area networks.

35. The system of claim 20, wherein:
the path determination mechanism is further configured to route the end-user to an alternate one of the first service provider and the second service provider to provide the requested one of the first service and the second service when a path is not available from the end-user to the selected one of the first service provider and the second service provider, and
the alternate one of the first service provider and the second service provider comprises one of a default and a randomly selected service provider.

36. A method for routing an end-user to a first service provider of a plurality of service providers for providing a first selected service over an access network and to a second service provider of the plurality of service providers for providing a second selected service over the access network, comprising the steps of:
populating a digital repository with a first indicator of an association between the end-user and the first service provider for providing the first selected service to the end-user;
populating the digital repository with a second indicator of an association between the end-user and the second service provider for providing the second selected service to the end-user;
requesting by the end-user to receive one of the first selected service and the second selected service;
querying the digital repository for one of the first indicator and the second indicator based on the end-user making a request in the requesting step and the one of the first selected service and the second selected service requested in the requesting step; and
routing the end-user to one of the first service provider and the second service provider corresponding to the one of the first indicator and the second indicator queried in the querying step.

37. The method of claim 36, wherein:
the requesting step comprises requesting the one of the first selected service and the second selected service over an access network providing a communication path between the end-user and a data center,
the routing step comprises routing the end-user through the access network to the data center, and from the data center to the one of the first service provider and the second service provider, and
the one of the first service provider and the second service provider provides the end-user with access to a service network providing the one of the first selected service and the second selected service.

38. The method of claim 36, wherein the access network comprises an open access network.

39. The method of claim 36, wherein the access network comprises at least one of a hybrid fiber optic/coaxial network, a digital subscriber line, a dialup connection, a fiber optic connection, a coaxial connection, a twisted pair connection, a cat5 connection, a cat5e connection, and a cat6 connection.

40. The method of claim 36, wherein the service network comprises at least one of an Internet protocol network, the Internet, a data network, a video network, and a voice network.

41. The method of claim 36, wherein at least one of the first service provider and the second service provider comprise at least one of an Internet service provider, a telephone company, a cable television company, a video content provider, a voice-over-Internet protocol provider, and a data services provider.

42. The method of claim 36, wherein at least one of the first selected service and the second selected service comprises at least one of data services, Internet access, voice services, telephone services, teleconferencing services, long distance telephone service, local telephone service, video services, video conferencing services, video on demand services, and cable television services.

43. The method of claim 36, wherein the step of routing comprises routing the end-user to the one of the first service provider and the second service provider by selecting at least one of a forwarding path, a channel, and a tunnel.

44. The method of claim 36, wherein:
the step of routing comprises routing the end-user to the one of the first service provider and the second service provider using at least one of source address routing, multi-protocol label switching, asynchronous transfer mode, private virtual circuits, switched virtual circuits, virtual local area networks, layer two tunneling protocol tunnels, Internet protocol secure tunnels, point-to-point tunneling protocol tunnels, and point-to-point protocol over ethernet.

45. The method of claim 36, further comprising the step of:
populating the digital repository with a third indicator of an association between the end-user and an alternate service provider for providing the first selected service to the end-user when the first selected service is not available from the first service provider, wherein
the routing step further comprises routing the end-user to the alternate service provider to provide the first selected service when a network path is not available from the end-user to the first service provider.

46. The method of claim 45, wherein:
the populating the digital repository with a third indicator step comprises populating the third indicator by at least one of
assigning a default service provider of the plurality of service providers for providing the first selected service,
randomly assigning a random service provider of the plurality of service providers for providing the first selected service based on a random selection, and
assigning a user-specified service provider of the plurality of service providers for providing the first selected service based on a user input.

47. The method of claim 36, further comprising a step of:
populating the digital repository with an end-user identification indicator corresponding to the end-user by at least one of an operator of the access network, an authorized agency, a governing entity, a regulatory entity, one of the plurality of end-users, one of the plurality of service providers, and a third party..

48. The method of claim 36, wherein:
the routing step further comprises routing the end-user to an alternate service provider to provide the first selected service when a network path is not available from the end-user to the first service provider, and
the alternate service provider comprises one of a default and a randomly selected service provider.

49. A computer program product, comprising:
a computer storage medium; and
a computer program code mechanism embedded in the computer storage medium for causing a computer to route an end-user to a first service provider of a plurality of service providers for providing a first service over an open access network and to a second service provider of the plurality of service providers for providing a second service over the open access network, the computer program code mechanism having
a first computer code device configured to populate a digital repository with a plurality of end-user service entries, each end-user service entry including
an end-user identification indicator corresponding to a unique one of the plurality of end-users,
a selected service indicator corresponding to a selected one of the first service and the second service, and
a selected service provider indicator corresponding to a selected one of the first service provider and the second service provider selected to provide the selected one of the first service and the second service to the unique one of the plurality of end-users,
a second computer code device configured to accept a request from the end-user for a requested one of the first service and the second service, and
a third computer code device configured to query the digital repository for a retrieved end-user service entry based on the end-user and the requested one of the first service and the second service and to provide a network path from the end-user to a selected one of the first service provider and the second service provider, the selected one of the first service provider and the second service provider being determined based on information stored in the retrieved end-user service entry.

50. The computer program product of claim 49, wherein
the request is made over an access network providing a communication path between the end-user and a data center,
the network path comprises a path from the end-user through the access network to the selected one of the first service provider and the second service provider, and
the selected one of the first service provider and the second service provider provides access to a service network providing the requested one of the first service and the second service.

51. The computer program product of claim 49 wherein the open access network comprises at least one of a hybrid fiber optic/coaxial network, a digital subscriber line, a dialup connection, a fiber optic connection, a coaxial connection, a twisted pair connection, a cat5 connection, a cat5e connection, and a cat6 connection.

52. The computer program product of claim 50, wherein the service network comprises at least one of an Internet protocol network, the Internet, a data network, a video network, and a voice network.

53. The computer program product of claim 49, wherein at least one of the first service provider and the second service provider comprise at least one of an Internet service provider, a telephone company, a cable television company, a video content provider, a voice-over-Internet protocol provider, and a data services provider.

54. The computer program product of claim 49, wherein at least one of the first service and the second service comprises at least one of data services, Internet access, voice services, telephone services, teleconferencing services, long distance telephone service, local telephone service, video services, video conferencing services, video on demand services, and cable television services.

55. The computer program product of claim 49, wherein the end-user identification indicator comprises at least one of a number, an Internet protocol address, a media access control address, a telephone number, a port number, a local area network tag, a virtual local area network tag, a multi-protocol label switch label, a label-switched path label, a label, a tag, a serial number, and a social security number.

56. The computer program product of claim 49, wherein the third computer code device is further configured to route the end-user to the selected one of the first service provider and the second service provider by selecting at least one of a forwarding path, a channel, and a tunnel.

57. The computer program product of claim 49, wherein the third computer code device is further configured to route the end-user to the selected one of the first service provider and the second service provider using at least one of source address routing, multi-protocol label switching, asynchronous transfer mode, private virtual circuits, switched virtual circuits, virtual local area networks, layer two tunneling protocol tunnels, Internet protocol secure tunnels, point-to-point tunneling protocol tunnels, and point-to-point protocol over ethernet.

58. The computer program product of claim 49, wherein:
each end-user service entry further includes
an alternate service provider indicator corresponding to an alternate one of the first service provider and the second service provider selected to alternately provide the requested one of the first service and the second service to the end-user, and
the third computer code device is further configured to route the end-user to the alternate one of the first service provider and the second service provider to provide the requested one of the first service and the second service when a network path is not available from the end-user to the selected one of the first service provider and the second service provider.

59. The computer program product of claim 58, wherein:
the first computer code device is further configured to populate the alternate service provider indicator by at least one of
assigning a default service provider of the plurality of service providers for providing the requested one of the first service and the second service,
randomly assigning a random service provider of the plurality of service providers for providing the requested one of the first service and the second service based on a random selection, and
assigning a user-specified service provider of the plurality of service providers for providing the requested one of the first service and the second service based on a user input.

60. The computer program product of claim 49, wherein:
the computer program code mechanism further has
a fourth computer code device configured to route the end-user to an alternate one of the first service provider and the second service provider to provide the requested one of the first service and the second service when a network path is not available from the end-user to the selected one of the first service provider and the second service provider, and
the alternate one of the first service provider and the second service provider comprises one of a default and a randomly selected service provider.

61. A system for providing a wholesale provisioning service, comprising:
a service provider selection mechanism configured to relate a particular service provider of a plurality of service providers to a particular end-user of a plurality of end-users for providing a particular service of a plurality of services to the particular end-user;
a service request mechanism configured to receive a request for the particular service from the particular end-user; and
a path determination mechanism configured to route the particular end-user to the particular service provider based on the request.
